(19) United States
(12) Patent Application Publication
(10) Pub. No.: US 2020/0309060 A1
(43) Pub. Date: Oct. 1, 2020

(54) CYLINDER SLEEVE ASSEMBLY FOR ENGINE BLOCK

(71) Applicant: Jeff Zaugg Incorporated, dba Advanced Sleeve, Mentor, OH (US)

(72) Inventor: Jeffrey B. Zaugg, Mentor, OH (US)

(73) Assignee: Jeff Zaugg Incorporated, dba Advanced Sleeve, Mentor, OH (US)

(21) Appl. No.: 16/820,875

(22) Filed: Mar. 17, 2020

Related U.S. Application Data
(60) Provisional application No. 62/825,417, filed on Mar. 28, 2019.

(51) Int. Cl. F02F 1/00

(52) U.S. Cl. CPC F02F 1/004

(57) ABSTRACT

It is described herein a cylinder sleeve assembly for an engine. The cylinder sleeve assembly may comprise a plurality of cylinder sleeves and a plurality of junctures. Each cylinder sleeve of the plurality of cylinder sleeves may comprise an outer cylinder sleeve wall, and an inner cylinder sleeve wall. Each juncture of the plurality of junctures connects two adjacent cylinder sleeves of the plurality of cylinder sleeves.

### CROSS REFERENCES AND PRIORITIES

This Application claims priority from U.S. Provisional Application No. 62/825,417 filed on 28 Mar. 2019 the teachings of which are incorporated by reference herein in their entirety.

### BACKGROUND

Internal combustion engines are known to generate a great amount of heat resulting from the combustion processes taking place in the engine block as well as friction generated heat from the various moving assemblies within the engine. Pistons move within cylinder bores toward and away from a cylinder head that includes intake and exhaust valves. The cylinder head seals the top end of a cylinder bore. The cylinder bores, cylinder head, and pistons form combustion chambers in the engine. As a piston travels upwardly toward the top of the cylinder bore, a gas/fuel mixture is compressed within the cylinder. The cylinder pressure can be up to or in excess of 10,000 psi. Prior to reaching the top of the piston travel, a spark and the compression of the mixture causes a controlled burn that can reach temperatures up to or in excess of 1,400° C. The controlled burning of the compressed gas/fuel mixture pushes the piston downward in the cylinder, thereby rotating a crankshaft. The burning of the gas/fuel mixture, and friction from the various moving assemblies, generates a significant amount of heat within the engine.

The operating temperature of an engine can generally be maintained within acceptable limits by the circulation of coolant in the engine block, around the cylinders, and through a portion of the cylinder head. Demands for greater horsepower output of engines, and for reduced hydrocarbon emissions in conjunction with catalyst systems, have both resulted in substantially increased combustion temperatures and hotter running engines. The increased temperatures occur primarily within the engine block, especially near the most highly heated top portions of the cylinders, near the cylinder head.

Some engines utilize cylinder sleeves that are inserted within the cylinder bores of an engine block. Alternatively, the engine block can be cast around the cylinder sleeves. If the sleeves come in contact with engine coolant, then the sleeves are referred to as wet sleeves. One early example of a wet sleeve is disclosed in U.S. Pat. No. 3,659,569 A which broadly discloses “at least one cooling tube, and preferably a plurality of cooling tubes arranged in semicircular assemblies and matching the curvature of the cylinder sleeve itself are cast into the head portion of the sleeve.”

In other configurations, the cylinder sleeves might be located totally within an existing cylinder bore of the engine, such that coolant does not come into contact with the cylinder sleeve. These sleeves are referred to as dry sleeves. One example of a dry sleeve is disclosed in U.S. Pat. No. 5,582,144 A which broadly disclosed “a dry liner for internal combustion engines having a flange on the outer circumference of a liner barrel, said liner barrel being inserted into the bore of a cylinder block, said flange being fastened between a cylinder head and said cylinder block.” Unfortunately without coolant contact, the most highly heated portion of the cylinder sleeve might not be adequately cooled.

Other configurations of cylinder sleeves can improve cooling flow. For example, some cylinder sleeves are provided with an upper collar or flange. The flange includes holes configured as vertical passageways that permit coolant to pass through the flange and into the cylinder head. This improves cooling of the selected upper flange area of the cylinder sleeve, but heat can still build up along the upper-most portion of the sleeve and in the hottest portions of high performance engines.

Recently, attempts have been made to improve the strength and rigidity of cylinder sleeves. One such attempt is disclosed in U.S. Pat. No. 6,799,541 B1 which discloses a “‘siamesed’ cylinder sleeve configuration” in which each cylinder sleeve is “finished with flat surfaces to enable two or more of the respective sleeves . . . to be fit together in an adjacent coupled configuration.”

As internal combustion engine technology continues to advance, the need exists for improved engine cylinder sleeves which meet the cooling, strength, and durability requirements of modern engines. This is particularly the case for high performance engines having higher compression ratios, increased torque, and/or increased horsepower.

### SUMMARY

A cylinder sleeve assembly for an engine block is disclosed. The cylinder sleeve assembly may comprise a plurality of cylinder sleeves and at least one juncture.

The plurality of cylinder sleeves may comprise at least a first cylinder sleeve and a second cylinder sleeve which may be adjacent to the first cylinder sleeve. Each cylinder sleeve of the plurality of cylinder sleeves may comprise an outer cylinder sleeve wall, an inner cylinder sleeve wall, a cylinder first end, a cylinder second end, and a cylinder length dimension. The cylinder length dimension spans from the cylinder first end to the cylinder second end.

Each juncture of the at least one juncture may connect two adjacent cylinder sleeves of the plurality of cylinder sleeves. Each juncture of the at least one juncture may comprise a juncture length dimension in parallel with the cylinder length dimension. The juncture length dimension may be less than or equal to the cylinder length dimension.

In some embodiments, at least one cylinder sleeve of the plurality of cylinder sleeves may have a first outside diameter beginning at the cylinder first end and extending along a first portion of the cylinder length dimension. Said at least one cylinder sleeve of the plurality of cylinder sleeves may also have a second outside diameter beginning at the cylinder sleeve second end and extending along a second portion of the cylinder length dimension. The first outside diameter may be greater than the second outside diameter. The first portion of the cylinder length dimension and the second potion of the cylinder length dimension preferably do not overlap. A sum of the first portion of the cylinder length dimension and the second portion of the cylinder length dimension may equal at least 95% of the cylinder length dimension.

In some embodiments where at least one cylinder sleeve of the plurality of cylinder sleeves has a first outside diameter and a second outside diameter, the sum of the first portion of the cylinder length dimension and the second portion of the cylinder length dimension may equal at least 99% of the cylinder length dimension. In certain such embodiments, the sum of the first portion of the cylinder length dimension and the second portion of the cylinder length dimension may equal 100% of the cylinder length dimension.

In some embodiments, each cylinder sleeve of the plurality of cylinder sleeves may have a first outside diameter beginning at the cylinder first end and extending along a first portion of the cylinder length dimension. Said at least one cylinder sleeve of the plurality of cylinder sleeves may also have a second outside diameter beginning at the cylinder sleeve second end and extending along a second portion of the cylinder length dimension. The first outside diameter may be greater than the second outside diameter. The first portion of the cylinder length dimension and the second potion of the cylinder length dimension preferably do not overlap. A sum of the first portion of the cylinder length dimension and the second portion of the cylinder length dimension may equal at least 95% of the cylinder length dimension.

In some embodiments where each cylinder sleeve of the plurality of cylinder sleeves has a first outside diameter and a second outside diameter, the sum of the first portion of the cylinder length dimension and the second portion of the cylinder length dimension may equal at least 99% of the cylinder length dimension. In certain such embodiments, the sum of the first portion of the cylinder length dimension and the second portion of the cylinder length dimension may equal 100% of the cylinder length dimension.

In some embodiments, the outer cylinder sleeve wall of at least one cylinder sleeve of the plurality of cylinder sleeves comprises at least one radial fin. In certain embodiments, the outer cylinder sleeve wall of each cylinder sleeve of the plurality of cylinder sleeves comprises at least one radial fin.

In some embodiments, at least one juncture of the at least one juncture may comprise at least one vertical through hole passing through the juncture in a vertical through hole plane substantially in parallel with the juncture length dimension. In certain embodiments, each juncture of the at least one juncture may comprise at least one vertical through hole passing through the juncture in a vertical through hole plane substantially in parallel with the juncture length dimension.

In some embodiments, at least one juncture of the at least one juncture may comprise at least one horizontal through hole passing through the juncture in a horizontal through hole plane substantially perpendicular to the juncture length dimension. In certain embodiments, each juncture of the at least one juncture may comprise at least one horizontal through hole passing through the juncture in a horizontal through hole plane substantially perpendicular to the juncture length dimension.

In some embodiments, at least one cylinder sleeve of the plurality of cylinder sleeves may comprise a flange. The flange in such embodiments may extend from a third portion of the outer cylinder sleeve wall located at the cylinder first end. The flange in such embodiments may have a flange top surface oriented in a first direction corresponding to the cylinder first end and a flange bottom surface oriented in a second direction corresponding to the cylinder second end.

In certain embodiments where at least one cylinder sleeve of the plurality of cylinder sleeves comprises a flange, the flange may comprise a flange groove located in the flange top surface. In some embodiments where at least one cylinder sleeve of the plurality of cylinder sleeves comprises a flange, the flange may comprise a plurality of flange through holes passing from the flange top surface through the flange to the flange bottom surface. Each such flange through hole of the plurality of flange through holes may be substantially in parallel with the cylinder length dimension.

In some embodiments, each cylinder sleeve of the plurality of cylinder sleeves may comprise a flange. The flange in such embodiments may extend from a third portion of the outer cylinder sleeve wall located at the cylinder first end. The flange in such embodiments may have a flange top surface oriented in a first direction corresponding to the cylinder first end and a flange bottom surface oriented in a second direction corresponding to the cylinder second end.

In certain embodiments where each cylinder sleeve of the plurality of cylinder sleeves comprises a flange, the flange may comprise a flange groove located in the flange top surface. In some embodiments where each cylinder sleeve of the plurality of cylinder sleeves comprises a flange, the flange may comprise a plurality of flange through holes passing from the flange top surface through the flange to the flange bottom surface. Each such flange through hole of the plurality of flange through holes may be substantially in parallel with the cylinder length dimension.

In some embodiments, the cylinder sleeve assembly may be inserted into the engine block.

### BRIEF DESCRIPTION OF FIGURES

FIG. 1 is a perspective exploded view of a prior art cylinder sleeve assembly.

FIG. 2 is a perspective assembled view of the prior art cylinder sleeve assembly of FIG. 1.

FIG. 3 is a perspective view of one embodiment of the invented cylinder sleeve assembly.

FIG. 4 is a top view of one embodiment of the invented cylinder sleeve assembly.

FIG. 5 is a side view of one embodiment of the invented cylinder sleeve assembly.

FIG. 6 is a perspective view of one embodiment of the invented cylinder sleeve assembly.

FIG. 7 is a perspective view of one embodiment of the invented cylinder sleeve assembly.

FIG. 8 is a top view of one embodiment of the invented cylinder sleeve assembly.

FIG. 9 is a side view of one embodiment of the invented cylinder sleeve assembly.

FIG. 10 is a side view of one embodiment of the invented cylinder sleeve assembly.

FIG. 11 is a perspective view of one embodiment of the invented cylinder sleeve assembly.

FIG. 12 is a perspective view of one embodiment of the invented cylinder sleeve assembly.

FIG. 13 is a perspective exploded view of one embodiment of the invented cylinder sleeve assembly with an engine block.

FIG. 14 is a perspective view of one embodiment of the invented cylinder sleeve assembly in an engine block.

FIG. 15A is a top view of one embodiment of the invented cylinder sleeve assembly.

FIG. 15B is a top view of one embodiment of the invented cylinder sleeve assembly.

FIG. 15C is a top view of one embodiment of the invented cylinder sleeve assembly.

FIG. 15D is a top view of one embodiment of the invented cylinder sleeve assembly.

FIG. 15E is a top view of one embodiment of the invented cylinder sleeve assembly.

### DETAILED DESCRIPTION

Disclosed herein is a cylinder sleeve assembly for a gasoline or diesel engine. The cylinder sleeve assembly is described below with reference to the Figures. As described herein and in the claims, the following reference numbers refer to the following structures as noted in the Figures.

5 refers to an engine block.

7 refers to cylinder bores.

10 refers to a cylinder sleeve assembly.

11 refers to an outer cylinder sleeve wall.

12 refers to an inner cylinder sleeve wall.

13 refers to a cylinder first end.

14 refers to a cylinder second end.

15 refers to a cylinder length dimension.

15A refers to a first portion of the cylinder length dimension.

15B refers to a second portion of the cylinder length dimension.

16 refers to a first outside diameter.

17 refers to a second outside diameter.

18 refers to a radial fin.

19 refers to an axial fin.

20 refers to a juncture.

20A refers to a first juncture.

20B refers to a second juncture.

20C refers to a third juncture.

20D refers to a fourth juncture.

20E refers to a fifth juncture.

20F refers to a sixth juncture.

20G refers to a seventh juncture.

21 refers to a juncture length dimension.

22 refers to a vertical through hole.

23 refers to a horizontal through hole.

30 refers to a flange.

31 refers to a flange top surface.

32 refers to a flange bottom surface.

33 refers to a flange groove.

34 refers to a plurality of flange through holes.

40 refers to a flat surface.

50 refers to a cylinder sleeve central axis.

50A refers to a first cylinder sleeve central axis.

50B refers to a second cylinder sleeve central axis.

50C refers to a third cylinder sleeve central axis.

50D refers to a fourth cylinder sleeve central axis.

50E refers to a fifth cylinder sleeve central axis.

50F refers to a sixth cylinder sleeve central axis.

50G refers to a seventh cylinder sleeve central axis.

50H refers to an eighth cylinder sleeve central axis.

100 refers to a first cylinder sleeve.

200 refers to a second cylinder sleeve.

300 refers to a third cylinder sleeve.

400 refers to a fourth cylinder sleeve.

500 refers to a fifth cylinder sleeve.

600 refers to a sixth cylinder sleeve.

700 refers to a seventh cylinder sleeve.

800 refers to an eighth cylinder sleeve.

L₁ refers to a line.

C₁ refers to a circumferential portion of the outer cylinder sleeve wall of the first cylinder sleeve.

C₂ refers to a circumferential portion of the outer cylinder sleeve wall of the second cylinder sleeve

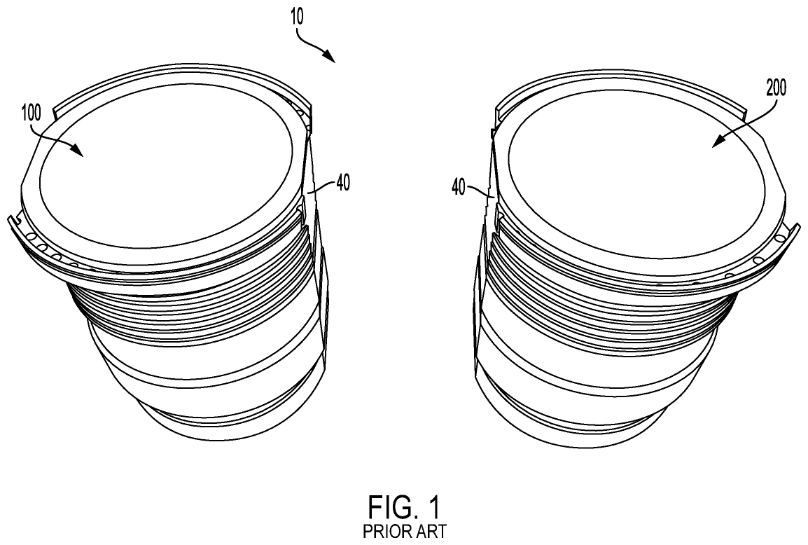

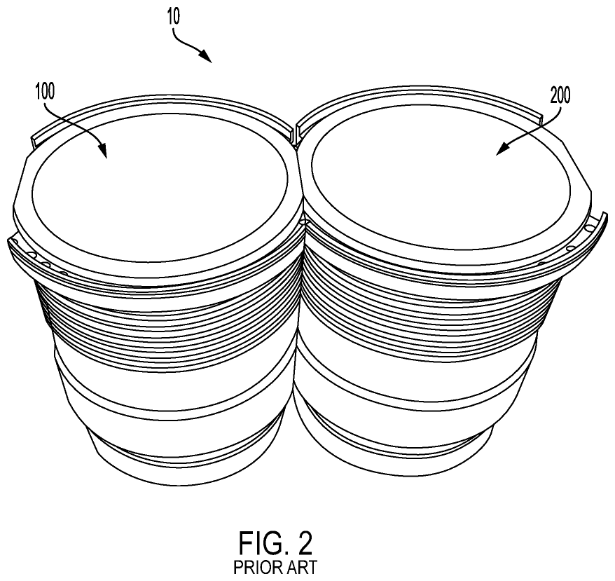

FIG. 1 and FIG. 2 depict perspective views of a cylinder sleeve assembly (10) known in the prior art. As shown in FIG. 1, which is the exploded view, the prior art cylinder sleeve assembly includes two or more cylinder sleeves—a first cylinder sleeve (100) and a second cylinder sleeve (200). Each cylinder sleeve includes at least one flat surface (40). When assembled, as shown in FIG. 2, the flat surface of one cylinder sleeve interacts with the flat surface of another cylinder sleeve to form the cylinder sleeve assembly.

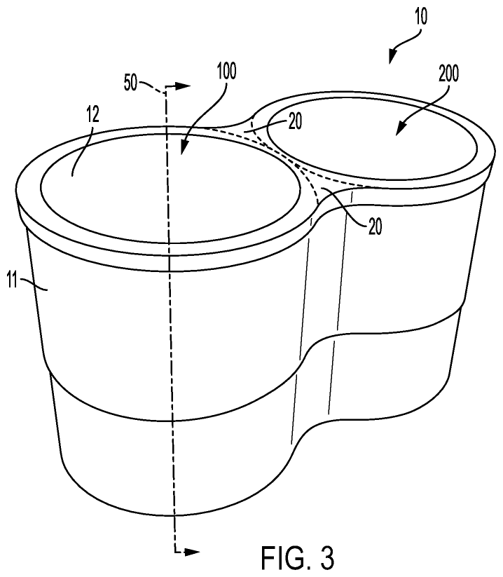

To improve the strength and rigidity of cylinder sleeve assemblies, the present invention utilizes two or more cylinder sleeves with each cylinder sleeve joined to at least one adjacent cylinder sleeve by a juncture. FIG. 3 depicts one embodiment of the invented cylinder sleeve assembly (10). As shown in FIG. 3, the cylinder sleeve assembly may comprise a plurality of cylinder sleeves. The plurality of cylinder sleeves comprises at least a first cylinder sleeve (100) and a second cylinder sleeve (200) adjacent to the first cylinder sleeve.

As shown in FIG. 3, each cylinder sleeve of the cylinder sleeve assembly (10) has an outer cylinder sleeve wall (11) and an inner cylinder sleeve wall (12). Each cylinder sleeve also has a cylinder sleeve central axis (50). While the outer cylinder sleeve wall, inner cylinder sleeve wall, and cylinder sleeve central axis are labelled with respect to only the first cylinder sleeve, one of ordinary skill will recognize that each cylinder sleeve of the plurality of cylinder sleeves will have its own independent outer cylinder sleeve wall, inner cylinder sleeve wall, and cylinder sleeve central axis. The cylinder sleeve assembly (10) also comprises a plurality of junctures with each juncture (20) of the plurality of junctures connecting two adjacent cylinder sleeves of the plurality of cylinder sleeves.

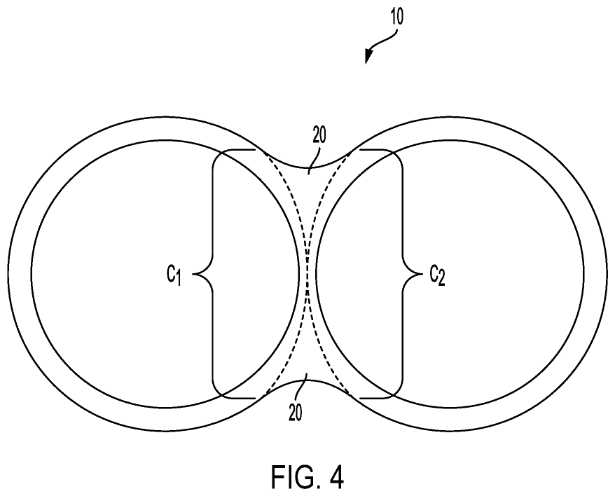

FIG. 4 depicts a top view of one embodiment of the cylinder sleeve assembly (10). As shown in FIG. 4, the juncture (20) attaches a projected circumferential portion of the outer cylinder sleeve wall of the first cylinder sleeve (C₁) to a projected circumferential portion of the outer cylinder sleeve wall of the second cylinder sleeve (C₂). As used herein and in the claims projected circumferential portion of the cylinder sleeve wall refers to a portion of the circumference of the outer cylinder sleeve wall that would exist but for the juncture. The projected circumferential portion of the outer cylinder sleeve wall of the first cylinder sleeve to which the juncture attaches relative to the total circumference of the outer cylinder sleeve wall of the first cylinder sleeve may be in a range selected from the group consisting of between 10% and 50%, between 10% and 40%, between 10% and 30%, and between 10% and 20%. Similarly, the projected circumferential portion of the outer cylinder sleeve wall of the second cylinder sleeve to which the juncture attaches relative to the total circumference of the outer cylinder sleeve wall of the second cylinder sleeve may be in a range selected from the group consisting of between 10% and 50%, between 10% and 40%, between 10% and 30%, and between 10% and 20%.

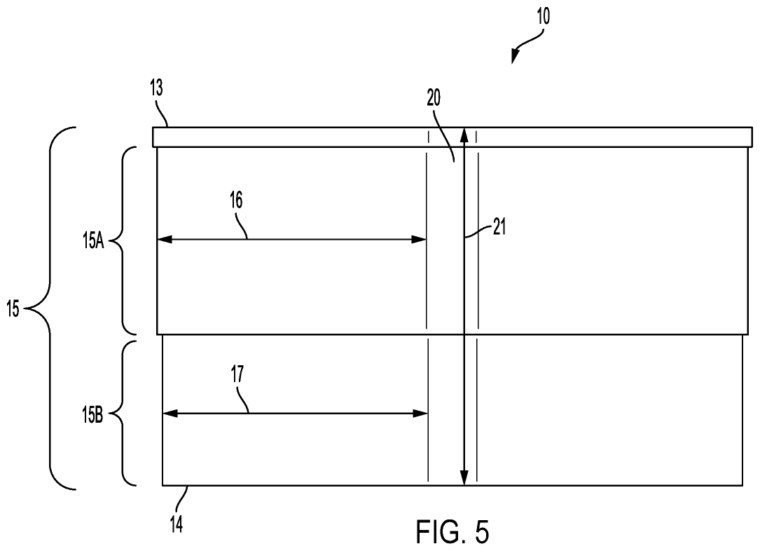

FIG. 5 depicts a side view of one embodiment of the cylinder sleeve assembly (10). As shown in FIG. 5, each cylinder sleeve also has a cylinder first end (13), and a cylinder second end (14) which is opposite of the cylinder first end. The cylinder first end and cylinder second end define a cylinder length dimension (15). While the cylinder first end, cylinder second end, and cylinder length dimension are labelled with respect to only the first cylinder sleeve, one of ordinary skill will recognize that each cylinder sleeve of the plurality of cylinder sleeves will have its own independent cylinder first end, cylinder second end, and cylinder length dimension.

As shown in FIG. 5, the juncture (20) comprises a juncture length dimension (21). In general, the juncture length dimension will be substantially in parallel with or in parallel with the cylinder length dimension (15) of at least one of the cylinder sleeves which are connected by the juncture. In some embodiments, the juncture length dimension may be equal to the cylinder length dimension of at least one of the cylinder sleeves which are connected by the juncture. In other embodiments, the juncture length dimension may be equal to the cylinder length dimension of both of the cylinder sleeves which are connected by the juncture. In still other embodiments, the juncture length dimension may be less than the cylinder length dimension of one or both of the cylinder sleeves which are connected by the juncture. In embodiments where the juncture length dimension is less than the cylinder length dimension of both of the cylinder sleeves which are connected by the juncture, the juncture may extend between any two points along the cylinder length dimension. For instance, the juncture may originate at the sleeve first end and extend along a portion of the cylinder length dimension, ending before the juncture reaches the cylinder second end. In other embodiments, the juncture may originate at the sleeve second end and extend along a portion of the cylinder length dimension, ending before the juncture reaches the cylinder first end. In still other embodiments, the juncture may originate at a first point along the cylinder length dimension proximate to the cylinder first end and extend along a portion of the cylinder length dimension, ending at a second point along the cylinder length dimension proximate to the cylinder second end.

FIG. 5 also shows at least one cylinder sleeve of the plurality of cylinder sleeves having a relief outside diameter. A relief outside diameter is a section of the cylinder sleeve having a smaller outside diameter than other areas of the cylinder sleeve. Typically, when present, the relief outside diameter will originate at the cylinder second end. It should be noted that a relief outside diameter is not necessary in all embodiments, and that certain embodiments will exist which do not contain a relief outside diameter.

The relief outside diameter, when present, may be described as the cylinder sleeve having a first outside diameter (16) beginning at the cylinder first end and extending along a first portion of the cylinder length dimension (15A), and a second outside diameter (17) beginning at the cylinder second end and extending along a second portion of the cylinder length dimension (15B). In such embodiments, the first outside diameter may be greater than or less than the second outside diameter. The first portion of the cylinder length dimension and the second portion of the cylinder length dimension will not overlap. That is to say that the second portion of the cylinder length dimension ends at the point along the cylinder length dimension at which the first portion of the cylinder length dimension begins. In some embodiments, the sum of the first portion of the cylinder length dimension and the second portion of the cylinder length dimension equals at least 95% of the cylinder length dimension with at least 99% of the cylinder length dimension being preferred, and 100% of the cylinder length dimension being even more preferred. When the sum of the first portion of the cylinder length dimension and the second portion of the cylinder length dimension is less than 100%, the remaining portion of the cylinder length dimension may comprise a flange as described herein.

While the relief outside diameter has been described with reference to one cylinder sleeve of the plurality of cylinder sleeves, one of ordinary skill will recognize that any number of cylinder sleeves of the plurality of cylinder sleeves may have a relief outside diameter. In some embodiments, each cylinder sleeve of the plurality of cylinder sleeves may have a relief outside diameter. The relief outside diameter may be utilized in conjunction with any other feature of the cylinder sleeve assembly disclosed herein, including any combination of radial fin(s), axial fin(s), vertical through hole(s), horizontal through hole(s), flange(s), flange groove(s), and flange through hole(s). When utilized in conjunction with one or more radial fin(s) and/or one or more axial fin(s), the dimensions of the fin(s) is/are not considered when measuring the outside diameter.

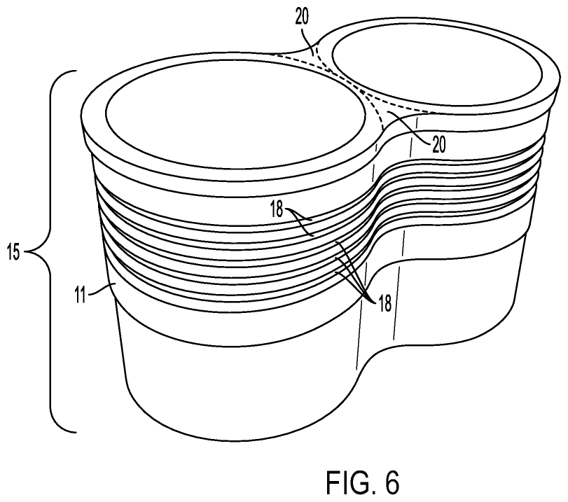

FIG. 6 depicts a radial fin (18). As shown in FIG. 6, at least one cylinder sleeve of the plurality of cylinder sleeves may comprise at least one radial fin. The radial fin(s) may be in the form of a protrusion or series of protrusions from the outer cylinder sleeve wall (11), or a ridge (rib) formed by two grooves or series of ridges (ribs) formed by a series of grooves applied to the outer cylinder sleeve wall. The radial fin(s), where present, are thought to improve cooling. The improved cooling is thought to be achieved—at least in part—by increasing the surface area of the outer cylinder sleeve wall which is exposed to a coolant, and by creating a more turbulent flow of the coolant around the outer cylinder sleeve wall. It should be noted that radial fin(s) is/are not necessary in all embodiments, and that certain embodiments will exist which do not contain any radial fins.

When present, the radial fin(s) (18) extend radially around at least a portion of the outer cylinder sleeve wall (11) which is not connected to a juncture (20) and is/are substantially perpendicular to or perpendicular to the cylinder length dimension (15). In some embodiments having at least one radial fin, at least one of the radial fin(s) extends radially around the entire portion of the outer cylinder sleeve wall which is not connected to a juncture. In other embodiments having at least one radial fin, each of the radial fin(s) extends radially around the entire portion of the outer cylinder sleeve wall which is not connected to a juncture. In some embodiments, such as shown in FIG. 6, at least one of the radial fin(s) may extend along an outer surface of a juncture between two adjacent cylinder sleeves. In other embodiments (not shown) none of the radial fin(s) extend along an outer surface of a juncture between two adjacent cylinder sleeves.

The number and orientation of radial fin(s) (18) for each individual cylinder wall is not considered important and will be largely a product of the requirements of the specific engine and its application. While it is preferred that—when at least one radial fin is present—each cylinder sleeve of the plurality of cylinder sleeves comprises at least one radial fin, embodiments are envisioned in which only a subset of all of the cylinder sleeves of the plurality of cylinder sleeves comprises at least one radial fin. The radial fin(s) may be utilized in conjunction with any other feature of the cylinder sleeve assembly disclosed herein, including any combination of relief outside diameter(s), axial fin(s), vertical through hole(s), horizontal through hole(s), flange(s), flange groove(s), and flange through hole(s).

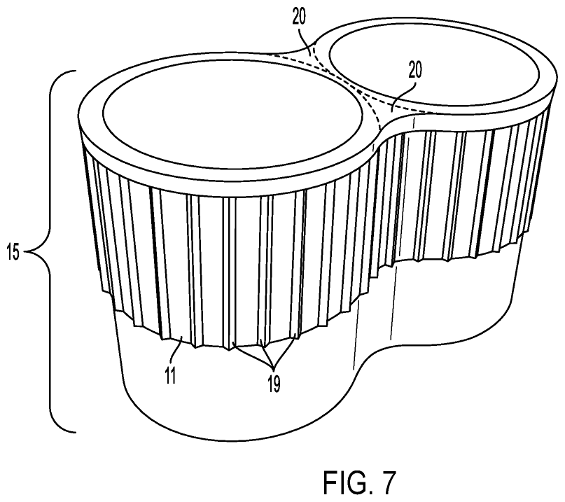

FIG. 7 depicts an axial fin (19). As shown in FIG. 7, at least one cylinder sleeve of the plurality of cylinder sleeves may comprise at least one axial fin. The axial fin(s) may be in the form of a protrusion or series of protrusions from the outer cylinder sleeve wall (11), or a ridge (rib) formed by two grooves or series of ridges (ribs) formed by a series of grooves applied to the outer cylinder sleeve wall. The axial fin(s), where present, are thought to improve cooling. The improved cooling is thought to be achieved—at least in part—by increasing the surface area of the outer cylinder sleeve wall which is exposed to a coolant, and by creating a more turbulent flow of the coolant around the outer cylinder sleeve wall. It should be noted that axial fin(s) is/are not necessary in all embodiments, and that certain embodiments will exist which do not contain any axial fins. In some embodiments, such as shown in FIG. 7, at least one of the axial fin(s) may extend along an outer surface of a juncture between two adjacent cylinder sleeves. In other embodiments (not shown) none of the axial fin(s) extend along an outer surface of a juncture between two adjacent cylinder sleeves.

When present, the axial fin(s) (19) extend substantially in parallel with or in parallel with the cylinder length dimension (15) along at least a portion of the outer cylinder sleeve wall (11) which is not connected to a juncture (20). Each individual axial fin may extend along all or less than all of the cylinder sleeve length dimension from the cylinder first end (13) to the cylinder second end (14). In some embodiments having at least one axial fin, at least one of the axial fins extends the entire cylinder sleeve length dimension from the cylinder sleeve first end to the cylinder sleeve second end. In other embodiments having at least one axial fin, each of the axial fins extends the entire cylinder sleeve length dimension from the cylinder sleeve first end to the cylinder sleeve second end.

The number and orientation of axial fin(s) (19) for each individual cylinder wall is not considered important and will be largely a product of the requirements of the specific engine and its application. While it is preferred that—when at least one axial fin is present—each cylinder sleeve of the plurality of cylinder sleeves comprises at least one axial fin, embodiments are envisioned in which only a subset of all of the cylinder sleeves of the plurality of cylinder sleeves comprises at least one axial fin. The axial fin(s) may be utilized in conjunction with any other feature of the cylinder sleeve assembly disclosed herein, including any combination of relief outside diameter(s), radial fin(s), vertical through hole(s), horizontal through hole(s), flange(s), flange groove(s), and flange through hole(s).

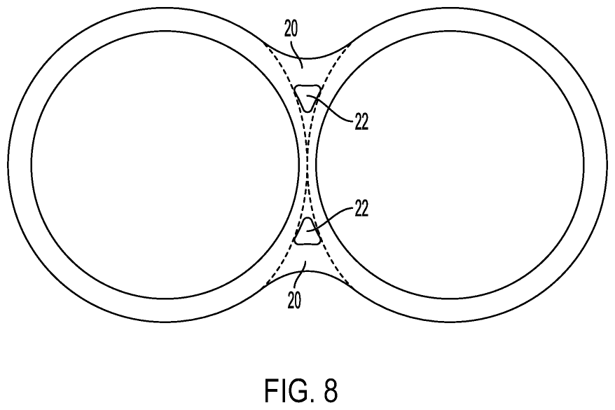

FIG. 8 depicts a vertical through hole (22) in the juncture (20). As shown in FIG. 8, at least one juncture of the plurality of junctures may comprise at least one vertical through hole. The vertical through hole, when present, is thought to improve cooling by allowing coolant to flow through the juncture. It should be noted that vertical through hole(s) is/are not necessary in all embodiments, and that certain embodiments will exist which do not contain any vertical through holes.

When present, the vertical through hole(s) (22) may pass through the juncture (20) in a vertical through hole plane substantially in parallel with or in parallel with the juncture length dimension (21 as shown in FIG. 5). As the vertical through hole passes through the entire juncture, the vertical through hole may be considered to have a length dimension which is equal to the juncture length dimension. In some embodiments, each juncture of the plurality of junctures may comprise at least one vertical through hole.

The number and orientation of vertical through hole(s) (22) for each individual juncture (20) is not considered important and will be largely a product of the requirements of the specific engine and its application. In some embodiments, at least one of the vertical through holes will be aligned with a water jacket of a cylinder head to be mounted on the engine block above the cylinder bores. In such embodiments, it is preferred that the vertical through hole have a size and shape which substantially matches or matches the size and shape of the corresponding water jacket. While it is preferred that—when at least one vertical through hole is present—each juncture of the plurality of junctures comprises at least one vertical through hole, embodiments are envisioned in which only a subset of all of the junctures of the plurality of junctures comprises a vertical through hole. The vertical through hole(s) may be utilized in conjunction with any other feature of the cylinder sleeve assembly disclosed herein, including any combination of relief outside diameter(s), radial fin(s), axial fins, horizontal through hole(s), flange(s), flange groove(s), and flange through hole(s).

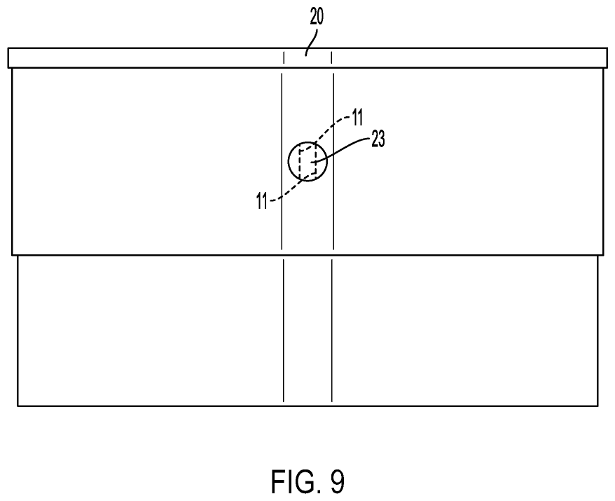

FIG. 9 depicts a horizontal through hole (23) in the juncture (20). As shown in FIG. 9, at least one juncture of the plurality of junctures may comprise at least one horizontal through hole. The horizontal through hole, when present, is thought to improve cooling by allowing coolant to flow through the juncture. It should be noted that horizontal through hole(s) is/are not necessary in all embodiments, and that certain embodiments will exist which do not contain any horizontal through holes.

When present, the horizontal through hole(s) (23) may pass through the juncture (20) in a horizontal through hole plane substantially perpendicular to or perpendicular to the juncture length dimension (21 as shown in FIG. 5). In some embodiments, each juncture of the plurality of junctures may comprise at least one horizontal through hole.

The number and orientation of horizontal through hole(s) (23) for each individual juncture (20) is not considered important and will be largely a product of the requirements of the specific engine and its application. While it is preferred that—when at least one horizontal through hole is present—each juncture of the plurality of junctures comprises at least one horizontal through hole, embodiments are envisioned in which only a subset of all of the junctures of the plurality of junctures comprises a horizontal through hole. The horizontal through hole(s) may be utilized in conjunction with any other feature of the cylinder sleeve assembly disclosed herein, including any combination of relief outside diameter(s), radial fin(s), axial fin(s), vertical through hole(s), flange(s), flange groove(s), and flange through hole(s).

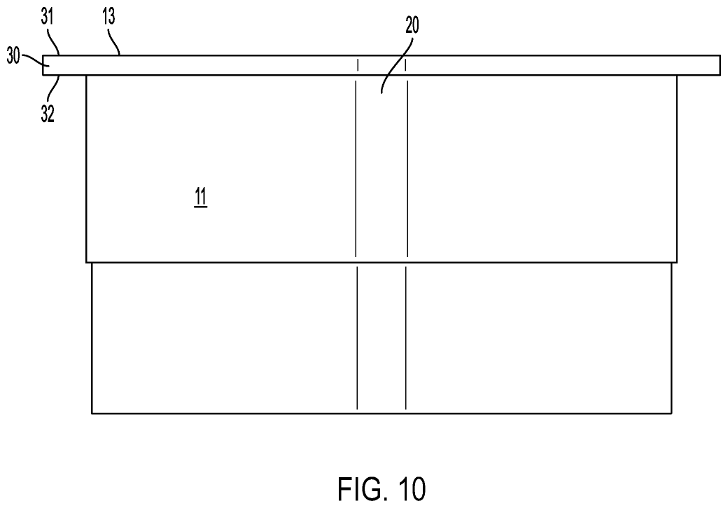

FIG. 10 depicts a flange (30). As shown in FIG. 10, at least one cylinder sleeve of the plurality of cylinder sleeves may comprise a flange. The flange, when present, may extend from a portion of the outer cylinder sleeve wall (11) located at the cylinder first end (13). As shown in FIG. 10, the flange extends only from the portion of the radius of the outer cylinder sleeve wall which is not connected to a juncture (20). In some embodiments, the flange will also extend through the juncture as shown in FIG. 10. However, embodiments may also exist where the flange does not extend through the juncture. When present, the flange will have a flange top surface (31) oriented in a first direction which corresponds to the cylinder first end. Similarly, the flange will have a flange bottom surface (32) oriented in a second direction corresponding to the cylinder second end. It should be noted that flange(s) is/are not necessary in all embodiments, and that certain embodiments will exist which do not contain a flange.

While it is preferred that—when the flange is present—each cylinder sleeve of the plurality of cylinder sleeves comprises a flange, embodiments are envisioned in which only a subset of all of the cylinder sleeves of the plurality of cylinder sleeves comprises a flange. The flange may be utilized in conjunction with any other feature of the cylinder sleeve assembly disclosed herein, including any combination of relief outside diameter(s), radial fin(s), axial fin(s), vertical through hole(s), horizontal through hole(s), flange groove(s), and flange through hole(s).

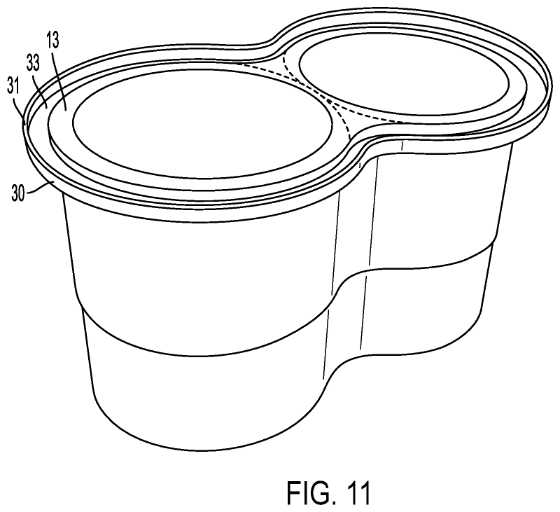

FIG. 11 depicts a flange groove (33). As shown in FIG. 11, when present, the flange groove may be located in the flange top surface (31). The flange groove, when present, provides a passageway for coolant to flow laterally around the cylinder first end (13), thereby improving the cooling effect at the cylinder first end. It should be noted that flange groove(s) is/are not necessary in all embodiments, and that certain embodiments will exist which do not contain a groove.

While it is preferred that—when the flange (30) is present—each flange comprises a flange groove, embodiments are envisioned in which only a subset of all of the flange(s) comprise a flange groove. The flange groove may be utilized in conjunction with any other feature of the cylinder sleeve assembly disclosed herein, including any combination of relief outside diameter(s), radial fin(s), axial fin(s), vertical through hole(s), horizontal through hole(s), and flange through hole(s).

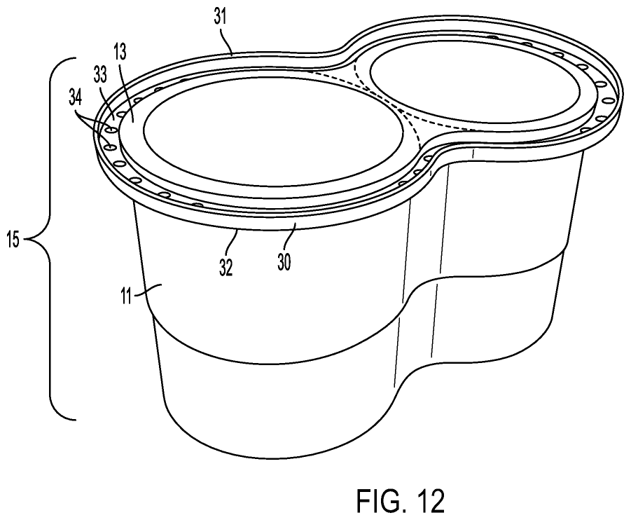

FIG. 12 depicts a plurality of flange through holes (34). As shown in FIG. 12, when present, each flange through hole of the plurality of flange through holes may pass from the flange top surface (31) through the flange to the flange bottom surface (32). Preferably, each flange through hole of the plurality of flange through holes will be substantially in parallel with or in parallel with the cylinder length dimension (15). The flange through holes, when present, provide a passageway for coolant to flow from the outer cylinder sleeve wall (11) into the flange groove (33) and/or a corresponding water jacket of a cylinder head, thereby improving the cooling effect at the cylinder first end (13) and/or within the cylinder head. It should be noted that flange through holes are not necessary in all embodiments, and that certain embodiments will exist which do not contain any flange through holes.

While it is preferred that—when the flange (30) is present—each flange comprises at least one flange through hole, embodiments are envisioned in which only a subset of all of the flange(s) comprise a flange through hole. The number and location of flange through holes is not considered important, and will be largely a product of the requirements of the specific engine and its application. In some embodiments, the number of flange through holes in each individual flange will be an integer in the range selected from the group consisting of between 1 and 50, between 1 and 40, between 1 and 30, between 1 and 20, and between 1 and 10. The flange through hole(s) may be utilized in conjunction with any other feature of the cylinder sleeve assembly disclosed herein, including any combination of relief outside diameter(s), radial fin(s), axial fin(s), vertical through hole(s), horizontal through hole(s), and flange groove(s).

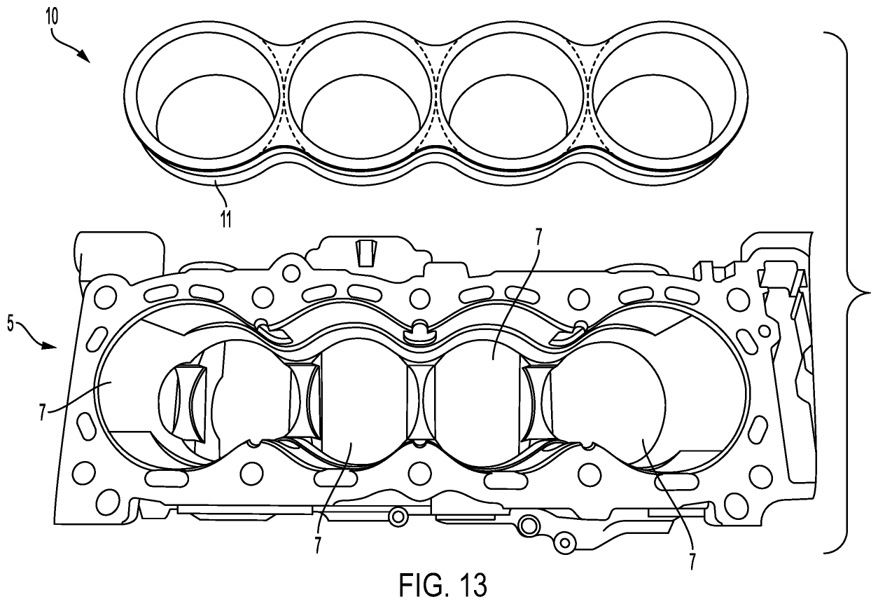

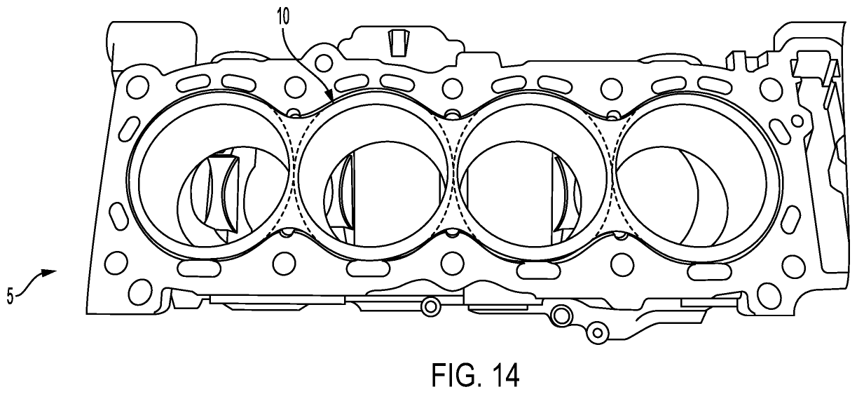

The cylinder sleeve assembly may be configured to be inserted into an engine block. FIG. 13 and FIG. 14 depict installation of a cylinder sleeve assembly (10) in an engine block (5). As shown in FIG. 13, the installation process begins by boring each of the existing cylinder bores (7) in the engine block that will receive the cylinder sleeve assembly to an appropriate diameter—also known as a bored-out diameter. The bored-out diameter may be slightly greater than, equal to, or slightly less than the outside diameter of the corresponding cylinder sleeve measured at the outer cylinder sleeve wall (11) depending upon the preferred method of installation. For instance, when the method of installation involves a clearance fit as discussed herein, the bored-out diameter may be between 0.001 and 0.010 inches greater than the outside diameter of the corresponding cylinder sleeve measured at the outer cylinder sleeve wall. Alternatively, when the method of installation involves an interference fit as discussed herein, the bored-out diameter may be between 0.001 and 0.010 inches less than the outside diameter of the corresponding cylinder sleeve measured at the outer cylinder sleeve wall.

In embodiments where one or more of the cylinder sleeves of the cylinder sleeve assembly has a relief outside diameter, a portion of the corresponding cylinder bores in the engine block may be bored to a second bored-out diameter. The second bored-out diameter preferably originates from the cylinder second end and has a length dimension which is substantially equal to or equal to the second portion of the cylinder length dimension. Preferably the second bored-out diameter is equal to or slightly less than the second outside diameter. In embodiments where one or more of the cylinder sleeves of the cylinder sleeve assembly has a flange, a flange diameter may be machined into the corresponding cylinder bore(s) in the engine block. The flange diameter will be located in the cylinder bore at a location corresponding to the cylinder first end.

After the engine block (5) has been bored to the bored-out diameter(s), the cylinder sleeve assembly (10) is inserted into the bored-out cylinder bores (7) using conventional processes known in the art. When the method of installation involves a clearance fit, the cylinder sleeve assembly (10) is inserted into the bored-out diameter of the corresponding cylinder bores of the engine block (5). An adhesive, such as an epoxy, is disposed and hardened between the outer cylinder sleeve wall(s) and the cylinder bores of the engine block to reduce or prevent dislodging of the cylinder sleeve assembly during operation. This is depicted in FIG. 14.

In embodiments where the method of installation involves an interference fit, the process of inserting the cylinder sleeve assembly into the bored-out cylinder bores may include heating the block to a temperature sufficient to expand the bored-out cylinder bores to a diameter slightly greater than the outside diameter(s) of the cylinder sleeves. The cylinder sleeve assembly is then inserted into the bored-out cylinder bores, and the block is allowed to cool. During cooling, the cylinder bores will shrink and engage the outer cylinder sleeve wall providing a frictional force which reduces or prevents dislodging of the cylinder sleeve assembly during operation. This method may be used in conjunction with an adhesive, such as an epoxy, disposed and hardened between the cylinder bore(s) and the outer cylinder sleeve wall(s) which provides further protection against dislodging during operation.

The engine block (5) with the cylinder sleeve assembly (10) inserted into the engine block may be subjected to any number of post-installation machining steps. In some embodiments, one or more of the cylinder sleeves of the cylinder sleeve assembly may be subjected to a honing procedure to ensure that the cylinder sleeve inside diameter is properly matched to the pistons used in the specific engine application. In some embodiments, the honing procedure may be conducted prior to installing the cylinder sleeve assembly into the engine block in addition to or instead of honing after installation. In some embodiments, the engine block may be subjected to a milling operation in which the surface of the block to which the cylinder heads are mounted is milled to a consistent height—also known as decking the block. Decking the block may occur with or without a honing procedure.

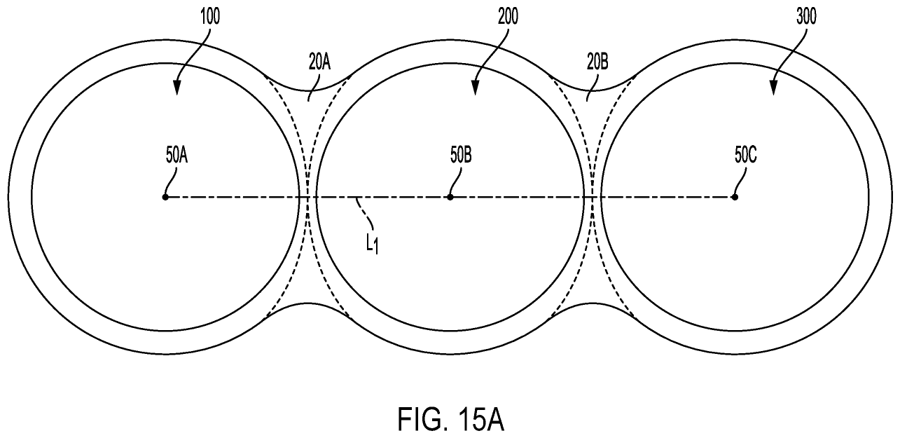

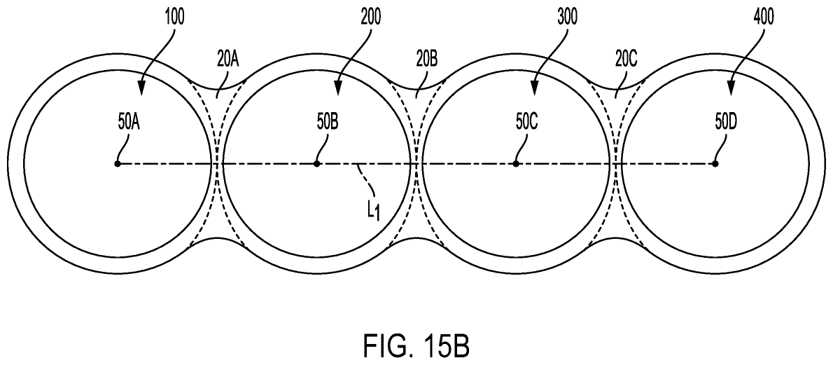

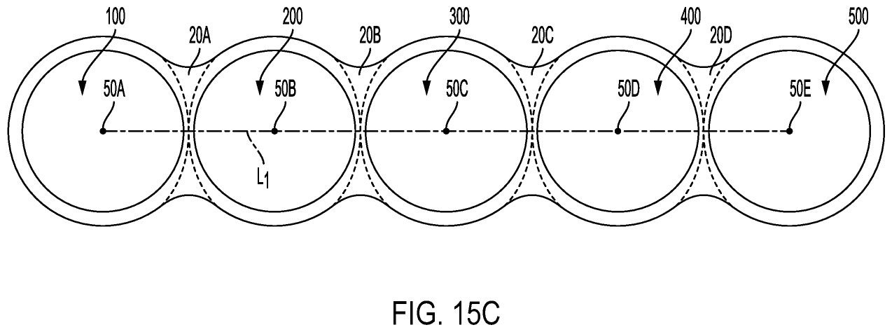

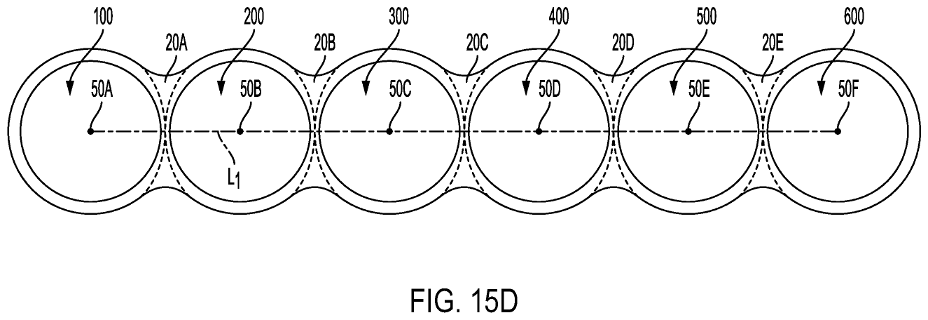

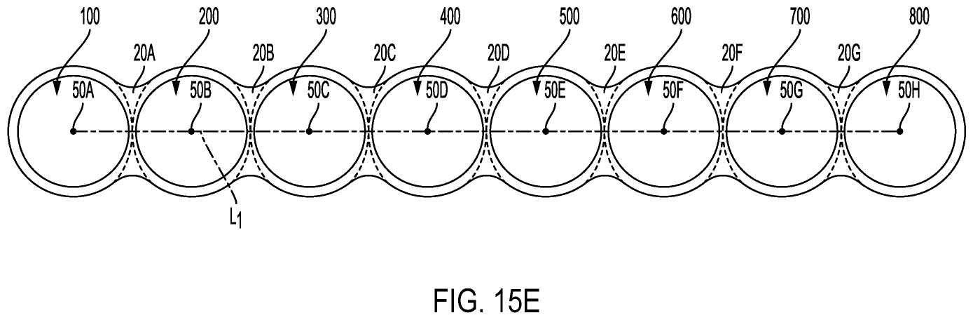

While the embodiments above have been described with reference to a cylinder sleeve assembly having two cylinder sleeves connected by one juncture, other embodiments may exist. For instance, FIG. 15A depicts an embodiment having three cylinder sleeves—a first cylinder sleeve (100), a second cylinder sleeve (200), and a third cylinder sleeve (300). In the embodiment depicted in FIG. 15A the first cylinder sleeve is joined by a first juncture (20A) to the second cylinder sleeve, and the second cylinder sleeve is joined by a second juncture (20B) to the third cylinder sleeve.

FIG. 15B depicts another embodiment having four cylinder sleeves—a first cylinder sleeve (100), a second cylinder sleeve (200), a third cylinder sleeve (300), and a fourth cylinder sleeve (400). In the embodiment depicted in FIG. 15B the first cylinder sleeve is joined by a first juncture (20A) to the second cylinder sleeve, the second cylinder sleeve is joined by a second juncture (20B) to the third cylinder sleeve, and the third cylinder sleeve is joined by a third juncture (20C) to the fourth cylinder sleeve.

FIG. 15C depicts another embodiment having five cylinder sleeves—a first cylinder sleeve (100), a second cylinder sleeve (200), a third cylinder sleeve (300), a fourth cylinder sleeve (400), and a fifth cylinder sleeve (500). In the embodiment depicted in FIG. 15C the first cylinder sleeve is joined by a first juncture (20A) to the second cylinder sleeve, the second cylinder sleeve is joined by a second juncture (20B) to the third cylinder sleeve, the third cylinder sleeve is joined by a third juncture (20C) to the fourth cylinder sleeve, and the fourth cylinder sleeve is joined by a fourth juncture (20D) to the fifth cylinder sleeve.

FIG. 15D depicts another embodiment having six cylinder sleeves—a first cylinder sleeve (100), a second cylinder sleeve (200), a third cylinder sleeve (300), a fourth cylinder sleeve (400), a fifth cylinder sleeve (500), and a sixth cylinder sleeve (600). In the embodiment depicted in FIG. 15D the first cylinder sleeve is joined by a first juncture (20A) to the second cylinder sleeve, the second cylinder sleeve is joined by a second juncture (20B) to the third cylinder sleeve, the third cylinder sleeve is joined by a third juncture (20C) to the fourth cylinder sleeve, the fourth cylinder sleeve is joined by a fourth juncture (20D) to the fifth cylinder sleeve, and the fifth cylinder sleeve is joined by a fifth juncture (20E) to the sixth cylinder sleeve.

FIG. 15E depicts another embodiment having eight cylinder sleeves—a first cylinder sleeve (100), a second cylinder sleeve (200), a third cylinder sleeve (300), a fourth cylinder sleeve (400), a fifth cylinder sleeve (500), a sixth cylinder sleeve (600), a seventh cylinder sleeve (700), and an eighth cylinder sleeve (800). In the embodiment depicted in FIG. 15E the first cylinder sleeve is joined by a first juncture (20A) to the second cylinder sleeve, the second cylinder sleeve is joined by a second juncture (20B) to the third cylinder sleeve, the third cylinder sleeve is joined by a third juncture (20C) to the fourth cylinder sleeve, the fourth cylinder sleeve is joined by a fourth juncture (20D) to the fifth cylinder sleeve, the fifth cylinder sleeve is joined by a fifth juncture (20E) to the sixth cylinder sleeve, the sixth cylinder sleeve is joined by a sixth juncture (20F) to the seventh cylinder sleeve, and the seventh cylinder sleeve is joined by a seventh juncture (20G) to the eighth cylinder sleeve.

The plurality of cylinder sleeves will typically be arranged in a successive linear pattern. In this regard, it is noted that each cylinder sleeve has its own cylinder sleeve central axis (50—as shown in FIG. 3) in parallel with the cylinder length dimension (15). As shown in FIG. 15A to FIG. 15E, in the cylinder sleeve assembly (10), a line (L₁) which is substantially straight or straight may be drawn starting from the first cylinder sleeve central axis (50A) of the first cylinder sleeve (100) through the cylinder sleeve central axis of each successive cylinder sleeve. For example, in FIG. 15A, the line (L₁) which originates from the first cylinder sleeve central axis (50A) of the first cylinder sleeve (100), and passes through the second cylinder sleeve central axis (50B) of the second cylinder sleeve (200) terminating at the third cylinder sleeve central axis (50C) of the third cylinder sleeve (300) is substantially straight or straight. In FIG. 15B, the line (L₁) which originates from the first cylinder sleeve central axis (50A) of the first cylinder sleeve (100), passes through the second cylinder sleeve central axis (50B) of the second cylinder sleeve (200) and the third cylinder sleeve central axis (50C) of the third cylinder sleeve (300), and terminates at the fourth cylinder sleeve central axis (50D) of the fourth cylinder sleeve (400) is substantially straight or straight. In FIG. 15C, the line (L₁) which originates from the first cylinder sleeve central axis (50A) of the first cylinder sleeve (100), passes through the second cylinder sleeve central axis (50B) of the second cylinder sleeve (200) the third cylinder sleeve central axis (50C) of the third cylinder sleeve (300) and the fourth cylinder sleeve central axis (50D) of the fourth cylinder sleeve (400), and terminates at the fifth cylinder sleeve central axis (50E) of the fifth cylinder sleeve (500) is substantially straight or straight. In FIG. 15D, the line (L₁) which originates from the first cylinder sleeve central axis (50A) of the first cylinder sleeve (100), passes through the second cylinder sleeve central axis (50B) of the second cylinder sleeve (200) the third cylinder sleeve central axis (50C) of the third cylinder sleeve (300) the fourth cylinder sleeve central axis (50D) of the fourth cylinder sleeve (400) and the fifth cylinder sleeve central axis (50E) of the fifth cylinder sleeve (500), and terminates at the sixth cylinder sleeve central axis (50F) of the sixth cylinder sleeve (600) is substantially straight or straight. In FIG. 15E, the line (L₁) which originates from the first cylinder sleeve central axis (50A) of the first cylinder sleeve (100), passes through the second cylinder sleeve central axis (50B) of the second cylinder sleeve (200) the third cylinder sleeve central axis (50C) of the third cylinder sleeve (300) the fourth cylinder sleeve central axis (50D) of the fourth cylinder sleeve (400) the fifth cylinder sleeve central axis (50E) of the fifth cylinder sleeve (500) the sixth cylinder sleeve central axis (50F) of the sixth cylinder sleeve (600) and the seventh cylinder sleeve central axis (50G) of the seventh cylinder sleeve (700), and terminates at the eighth cylinder sleeve central axis (50H) of the eighth cylinder sleeve (800) is substantially straight or straight.

One of ordinary skill will recognize that the number of cylinder sleeves in the cylinder sleeve assembly will often be a product of the particular engine application for which the cylinder sleeve assembly is used. For instance, when the cylinder sleeve assembly is used for all cylinder bores in a standard V-8 engine, one of ordinary skill would select two separate cylinder sleeve assemblies, each having four cylinder sleeves. In another example, when the cylinder sleeve assembly is used for all cylinder bores in an in-line 6 cylinder engine, one of ordinary skill would select a cylinder sleeve assembly having six cylinder sleeves. In some embodiments, the cylinder sleeve assembly may be used with less than all of the cylinder bores in the particular engine. This may particularly be the case where one of ordinary skill is using the cylinder sleeve assembly to repair damaged cylinder bores in an existing engine block. For example, where two adjacent cylinder bores in an existing engine block are damaged, one of ordinary skill may choose to repair them using a cylinder sleeve assembly having two cylinder sleeves.

The cylinder sleeve assembly may be manufactured by any number of different methods. In some embodiments, each cylinder sleeve of the plurality of cylinder sleeves, and each juncture of the plurality of junctures may be manufactured as a single integral piece of material. Manufacturing from a single integral piece of material may be accomplished by casting or forging the cylinder sleeve assembly, or by subtractive manufacturing, or by additive manufacturing.

In subtractive manufacturing embodiments, the cylinder sleeve assembly will begin as a solid block of metal material—often referred to as a billet or ingot. The solid block of metal material is then machined such as by a mill, a CNC mill, a lathe, a CNC lathe, or the like which removes material to form the plurality of cylinder sleeves and the plurality of junctures. Further material may be removed to form additional features such as relief outside diameter(s), radial fin(s), axial fin(s), vertical through hole(s), horizontal through hole(s), flange(s), flange groove(s), and flange through hole(s). If the cylinder sleeve assembly is made by casting or forging, post-casting or post-forging machining—i.e. subtractive manufacturing after casting or forging—may be needed to form specific features such as relief outside diameter(s), radial fin(s), axial fin(s), vertical through hole(s), horizontal through hole(s), flange(s), flange groove(s), and flange through hole(s).

In additive manufacturing embodiments, metal material is joined or solidified under computer control to create the cylinder sleeve assembly. Commonly known as 3D printing or metal 3D printing, additive manufacturing allows the cylinder sleeve assembly to be made from a computer-aided-design (CAD) model by successively adding metal material layer by layer. The additive manufacturing process allows for any number of additional features to be formed as the layers are added—including relief outside diameter(s), radial fin(s), axial fin(s), vertical through hole(s), horizontal through hole(s), flange(s), flange groove(s), and flange through hole(s). One common type of additive manufacturing is known as fused deposition modeling (FDM).

Alternatively, the cylinder sleeve assembly may be formed by first manufacturing each individual cylinder sleeve of the plurality of cylinder sleeves (such as by casting, forging, subtractive manufacturing, or additive manufacturing), and then joining the individual cylinder sleeves to one another and forming juncture(s) between each individual cylinder sleeve prior to installing the cylinder sleeve assembly into the engine block. In such embodiments, the juncture(s) may be formed by welding a portion of the outer cylinder sleeve wall of one cylinder sleeve to a portion of the outer cylinder sleeve wall of another cylinder sleeve. In such embodiments, the weld is considered to form all or part of the juncture. Alternatively, the juncture(s) may be formed by placing a portion of the outer cylinder sleeve wall of one cylinder sleeve in contact with a portion of the outer cylinder sleeve wall of another cylinder sleeve, and then affixing the two cylinder sleeves to one another with an adhesive such as an epoxy. In such embodiments, the adhesive is considered to form all or part of the juncture. For increased strength and to assist in aligning the two cylinder sleeves, a weld juncture or an adhesive juncture may include one or more pins with each pin extending between a blind hole in the outer cylinder sleeve wall of one cylinder sleeve and a corresponding blind hole in the outer cylinder sleeve wall of another cylinder sleeve. Preferably these blind holes, when present, will be substantially perpendicular to or perpendicular to the cylinder length dimension.

The cylinder sleeve assembly may comprise a number of different types of metal materials. A preferred metal material is ductile iron. Other metal materials may include gray iron and aluminum.

By connecting each cylinder sleeve of the plurality of cylinder sleeves with a juncture, the cylinder sleeve assembly can achieve improved strength and rigidity. This is particularly important for high performance engines which are subject to failures due to higher operating temperatures, increased torque, increased compression ratio, and increased horsepower among other factors. Additionally, connecting each cylinder sleeve of the plurality of cylinder sleeves with a juncture the cylinder sleeves can be more accurately aligned to one another prior to installation in an engine block, thereby reducing or eliminating alignment errors which can cause catastrophic engine failures or time intensive post-installation repairs.

### EXPERIMENTAL

Control and experimental runs were conducted using an in-line four cylinder Hayabusa® motorcycle engine modified for drag racing applications weighing 750 lbs. The engine had a bore (cylinder diameter) of 84 mm and a compression ratio of 12.2:1. The engine had a measured horsepower of 265 HP. The engine operated on C23 Racing Fuel available from VP Racing Fuels, Inc. of San Antonio, Tex., U.S.A. with a 300 HP boost of nitrous oxide for a final horsepower of 565 HP.

For both the control and experimental runs, the engine was installed in a custom-made chain driven drag racing motorcycle having a seventy (70) inch wheelbase which was driven down a standard quarter mile drag strip. During operation, the engine achieved rpms of approximately 12,500. For each drive down the drag strip (also known as a “pass”) the motorcycle was timed, and its top speed recorded. Times ranged between 7.56 seconds and 7.69 seconds while top speeds ranged up to 191 mph.

Following each pass, the engine was partially disassembled and serviced. During the disassembly and service process, the cylinder sleeve assemblies were observed for damage or other evidence of a failure.

A prior art cylinder sleeve assembly of the type shown in FIG. 1 and FIG. 2 was used as the control. The prior art cylinder sleeve assembly consisted of four individual cylinder sleeves manufactured of ductile iron which were not connected by a juncture. Each individual cylinder sleeve in the control comprised at least one flat surface for interacting with a flat surface of another cylinder sleeve to form the cylinder sleeve assembly. The prior art cylinder sleeve assembly was installed using an interference fit installation method having a 0.002 inch interference. The prior art cylinder sleeve assemblies for the control experiment contained a relief outside diameter, but did not contain a radial fin, an axial fin, a vertical through hole, a horizontal through hole, a flange, a flange groove, or a flange through hole.

A cylinder sleeve assembly with junctures connecting each cylinder sleeve as disclosed herein was used as the experimental. The experimental cylinder sleeve assembly was installed using an interference fit installation method having a 0.002 inch interference fit. The experimental cylinder sleeve assembly contained a relief outside diameter, but did not contain a radial fin, an axial fin, a vertical through hole, a horizontal through hole, a flange, a flange groove, or a flange through hole.

Following the first pass, the control cylinder sleeve assembly displayed evidence of damage. Specifically, the individual cylinder sleeves were observed to be “rocking” within the engine block during operation and causing damage to the cylinder head gasket. It is believed that this “rocking” is caused by one or more of the individual cylinder sleeves becoming partially uninstalled from the engine block during operation. This required replacement of the cylinder head gasket before the second pass and each subsequent pass.

The experimental cylinder sleeve assembly displayed no evidence of damage after twenty (20) passes. Specifically, no evidence of “rocking” within the engine block was observed, and the same cylinder head gasket was capable of being reused for subsequent passes. After the first twenty (20) passes, the engine block was decked, the engine was reassembled, and a second twenty (20) passes were run. Again, no evidence of damage was observed after the second twenty (20) passes.

What is claimed is:

1. A cylinder sleeve assembly (10) for an engine block (5) comprising:
a plurality of cylinder sleeves comprising at least a first cylinder sleeve (100) and a second cylinder sleeve (200) adjacent to the first cylinder sleeve wherein each cylinder sleeve of the plurality of cylinder sleeves comprises an outer cylinder sleeve wall (11), an inner cylinder sleeve wall (12), a cylinder first end (13), a cylinder second end (14), and a cylinder length dimension (15) spanning from the cylinder first end to the cylinder second end; and
at least one juncture wherein each juncture (20) of the at least one juncture connects two adjacent cylinder sleeves of the plurality of cylinder sleeves, each juncture of the at least one juncture comprises a juncture length dimension (21) in parallel with the cylinder length dimension, and the juncture length dimension is less than or equal to the cylinder length dimension.

2. The cylinder sleeve assembly of claim 1, wherein at least one cylinder sleeve of the plurality of cylinder sleeves has a first outside diameter (16) beginning at the cylinder first end and extending along a first portion of the cylinder length dimension (15A), and a second outside diameter (17) beginning at the cylinder second end and extending along a second portion of the cylinder length dimension (15B) wherein the first outside diameter is greater than the second outside diameter, the first portion of the cylinder length dimension and the second portion of the cylinder length dimension do not overlap, and a sum of the first portion of the cylinder length dimension and the second portion of the cylinder length dimension equals at least 95% of the cylinder length dimension.

3. The cylinder sleeve assembly of claim 2, wherein the sum of the first portion of the cylinder length dimension and the second portion of the cylinder length dimension equals at least 99% of the cylinder length dimension.

4. The cylinder sleeve assembly of claim 2, wherein the sum of the first portion of the cylinder length dimension and the second portion of the cylinder length dimension equals 100% of the cylinder length dimension.

5. The cylinder sleeve assembly of claim 1, wherein each cylinder sleeve of the plurality of cylinder sleeves has a first outside diameter (16) beginning at the cylinder first end and extending along a first portion of the cylinder length dimension (15A), and a second outside diameter (17) beginning at the cylinder second end and extending along a second portion of the cylinder length dimension (15B) wherein the first outside diameter is greater than the second outside diameter, the first portion of the cylinder length dimension and the second portion of the cylinder length dimension do not overlap, and a sum of the first portion of the cylinder length dimension and the second portion of the cylinder length dimension equals at least 95% of the cylinder length dimension.

6. The cylinder sleeve assembly of claim 5, wherein the sum of the first portion of the cylinder length dimension and the second portion of the cylinder length dimension equals at least 99% of the cylinder length dimension.

7. The cylinder sleeve assembly of claim 5, wherein the sum of the first portion of the cylinder length dimension and the second portion of the cylinder length dimension equals 100% of the cylinder length dimension.

8. The cylinder sleeve assembly of claim 1, wherein the outer cylinder sleeve wall of at least one cylinder sleeve of the plurality of cylinder sleeves comprises at least one radial fin (18).

9. The cylinder sleeve assembly of claim 1, wherein the outer cylinder sleeve wall of each cylinder sleeve of the plurality of cylinder sleeves comprises at least one radial fin (18).

10. The cylinder sleeve assembly of claim 1, wherein at least one juncture of the at least one juncture comprises at least one vertical through hole (22) passing through the juncture in a vertical through hole plane substantially in parallel with the juncture length dimension.

11. The cylinder sleeve assembly of claim 1, wherein each juncture of the at least one juncture comprises at least one vertical through hole (22) passing through the juncture in a vertical through hole plane substantially in parallel with the juncture length dimension.

12. The cylinder sleeve assembly of claim 1, wherein at least one juncture of the at least one juncture comprises at least one horizontal through hole (23) passing through the juncture in a horizontal through hole plane substantially perpendicular to the juncture length dimension.

13. The cylinder sleeve assembly of claim 1, wherein each juncture of the at least one juncture comprises at least one horizontal through hole (23) passing through the juncture in a horizontal through hole plane substantially perpendicular to the juncture length dimension.

14. The cylinder sleeve assembly of claim 1, wherein at least one cylinder sleeve of the plurality of cylinder sleeves further comprises a flange (30) extending from a third portion of the outer cylinder sleeve wall located at the cylinder first end, said flange having a flange top surface (31) oriented in a first direction corresponding to the cylinder first end and a flange bottom surface (32) oriented in a second direction corresponding to the cylinder second end.

15. The cylinder sleeve assembly of claim 14, wherein the flange comprises a flange groove (33) located in the flange top surface.

16. The cylinder sleeve assembly of claim 14, wherein the flange comprises a plurality of flange through holes (34) passing from the flange top surface through the flange to the flange bottom surface wherein each flange through hole of the plurality of flange through holes is substantially in parallel with the cylinder length dimension.

17. The cylinder sleeve assembly of claim 1, wherein each cylinder sleeve of the plurality of cylinder sleeves further comprises a flange (30) extending from a third portion of the outer cylinder sleeve wall located at the cylinder first end, said flange having a flange top surface (31) oriented in a first direction corresponding to the cylinder first end and a flange bottom surface (32) oriented in a second direction corresponding to the cylinder second end.

18. The cylinder sleeve assembly of claim 17, wherein the flange comprises a flange groove (33) located in the flange top surface.

19. The cylinder sleeve assembly of claim 17, wherein the flange comprises a plurality of flange through holes (34) passing from the flange top surface through the flange to the flange bottom surface wherein each flange through hole of the plurality of flange through holes is substantially in parallel with the cylinder length dimension.

20. The cylinder sleeve assembly of claim 1, wherein said cylinder sleeve assembly is inserted into the engine block.
